(19) United States
(12) Patent Application Publication
(10) Pub. No.: US 2016/0188721 A1
(43) Pub. Date: Jun. 30, 2016

(54) Accessing Multi-State Search Results

(71) Applicant: Quixey, Inc., Mountain View, CA (US)

(72) Inventors: Eric J. Glover, Palo Alto, CA (US); James Delli Santi, San Jose, CA (US); Matthew Thomas Elder, Los Altos, CA (US)

(73) Assignee: Quixey, Inc., Mountain View, CA (US)

(21) Appl. No.: 14/982,968

(22) Filed: Dec. 29, 2015

Related U.S. Application Data
(60) Provisional application No. 62/099,093, filed on Dec. 31, 2014.

(51) Int. Cl. G06F 17/30

(52) U.S. Cl. CPC G06F 17/30864; G06F 17/30905

(57) ABSTRACT

A method includes transmitting, by a processing system included in a user device, a query wrapper including a search query and a multi-state request to a remote device. The method further includes receiving search results from the remote device, wherein the search results include a multi-state result. The multi-state result includes multi-state instructions and access mechanisms that may be used to launch a primary application state and one or more secondary application states. The method further includes displaying the multi-state result as a user-selectable link in a search engine results page, whereby the user-selectable link indicates the primary application state. Additionally, the method includes launching the primary application state and the one or more secondary application states indicated by the multi-state result according to the multi-state instructions and access mechanisms.

### CROSS REFERENCE TO RELATED APPLICATIONS

This U.S. patent application claims priority under 35 U.S.C. §119(e) to U.S. Provisional Application 62/099,093, filed on Dec. 31, 2014, which is hereby incorporated by reference in its entirety.

### TECHNICAL FIELD

This disclosure relates to accessing search results that connect users to multiple application states.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications to games, educational applications, news applications, shopping applications, messaging applications, media streaming applications, social networking applications, and so much more. Furthermore, application developers develop vast amounts of applications within each genre and each application may have numerous editions. As a result, users of these Internet-connected devices have encountered the problem of finding the correct native or web software application offering the information and/or functionality that they seek. In response to this problem, techniques have arisen to connect users of these devices to relevant application and web content.

### SUMMARY

In one example, a method includes transmitting, by a processing system included in a user device, a query wrapper including a search query and a multi-state request to a remote device. The method further includes receiving search results from the remote device, wherein the search results include a multi-state result. The multi-state result includes multi-state instructions and access mechanisms that may be used to launch a primary application state and one or more secondary application states. The method further includes displaying the multi-state result as a user-selectable link in a search engine results page, whereby the user-selectable link indicates the primary application state. Additionally, the method includes launching the primary application state and the one or more secondary application states indicated by the multi-state result according to the multi-state instructions and access mechanisms.

In another example, a system includes a user device including a processing system, the processing system including one or more processors that execute computer-readable instructions, the computer readable instructions, when executed by the processing system, cause the processing system to transmit a query wrapper including a search query and a multi-state request to a remote device and receive search results from the remote device, the search results including a multi-state result. The multi-state result includes multi-state instructions and access mechanisms that may be used to launch a primary application state and one or more secondary application states. The one or more processors are further configured to display the multi-state result as a user-selectable link in a search engine results page, the user-selectable link indicating the primary application state. Additionally, the one or more processors are configured to launch the primary application state and the one or more secondary application states of the multi-state result according to the multi-state instructions and access mechanisms.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example environment including a user device in communication with a search system.

FIG. 2 is a schematic view of an example user device in communication with a search system.

FIGS. 3A-3C are schematic views of a user display illustrating a search engine results page, a primary application state, and a subsequent application state.

FIG. 4A is a schematic view of a user device displaying a search engine results page including a non-interactive multi-state search result.

FIG. 4B is a schematic view of a user device displaying a search engine results page including an interactive multi-state search result.

FIG. 5A is schematic views of a user device displaying a search engine results page including an interactive multi-state search result.

FIGS. 5B-5C are schematic views of a user device displaying a launcher overlay including user-selectable links to secondary application states over a current application.

FIGS. 6A and 6B are schematic views of a user device launching and displaying multiple application states in parallel.

FIGS. 7A and 7B are schematic views of a user device displaying concealed secondary results.

FIGS. 8A and 8B are schematic views of an example individual application state record.

FIG. 8C is a schematic view of an example multi-state record.

FIG. 9 is a schematic view illustrating an example method for generating search results including multi-state search results.

FIG. 10 is a schematic view illustrating an example method for generating search results including multi-state search results.

FIGS. 11-13 are schematic views illustrating example methods for requesting, receiving, and handling multi-state search results at user device.

FIG. 14 is a functional block diagram illustrating an example search module.

FIG. 15 is a schematic view of an example computing device executing any systems or methods described herein.

Like reference symbols in the various drawings indicate like elements.

### DETAILED DESCRIPTION

A search system of the present disclosure generates search results that may include individual search results and one or more multi-state search results. A user device may set a single application into a state in response to user selection of an individual search result (e.g., according to an access mechanism of the individual search result). A multi-state search result may include multiple access mechanisms that may be used sequentially and/or in parallel (e.g., simultaneously) at the user device. For example, in response to selection of a multi-state search result, a user device may launch one or more applications referenced in the multiple access mechanisms and set the one or more applications into states specified in the multiple access mechanisms.

In some implementations, a user may select a multi-state search result, which may cause a user device to launch applications in parallel (e.g., in different window(s) than the window displaying a current application) and set each of the launched applications into states specified by the access mechanisms of the multi-state search result. In other implementations, a user may select a multi-state search result causing the user device 200 to launch a single application and then provide the user links to additional application states (e.g., subsequent states) via access mechanisms included in the multi-state search result. In other implementations, a user's selection of a multi-state search result may cause the user device to launch a single initial application state and then, at a later time, automatically launch a subsequent application state (e.g., in response to a trigger, such as a user reaching a specified state or performing a specified action).

A multi-state search result includes references to a primary application state and one or more secondary application states. A multi-state search result 220b can include multiple access mechanisms corresponding to the primary and secondary application states. A multi-state search result 220b can additionally include multi-state instructions 410 that indicate to a user device how to handle the multiple access mechanisms. For example, the multi-state instructions may instruct at least one of the operating system (OS), a search application (e.g., the native search application presenting the multi-state results), a different native application, and another program (e.g., a launcher program) how to handle the multiple access mechanisms included in the multi-state search result. A user device may include a multi-state module 217 configured to implement functionality on the user device that requests and handles the multi-state search result, such as requesting a number of multi-state results, launching the applications referenced in a multi-state result, and providing a user interface for launching the applications according to the multi-state instructions.

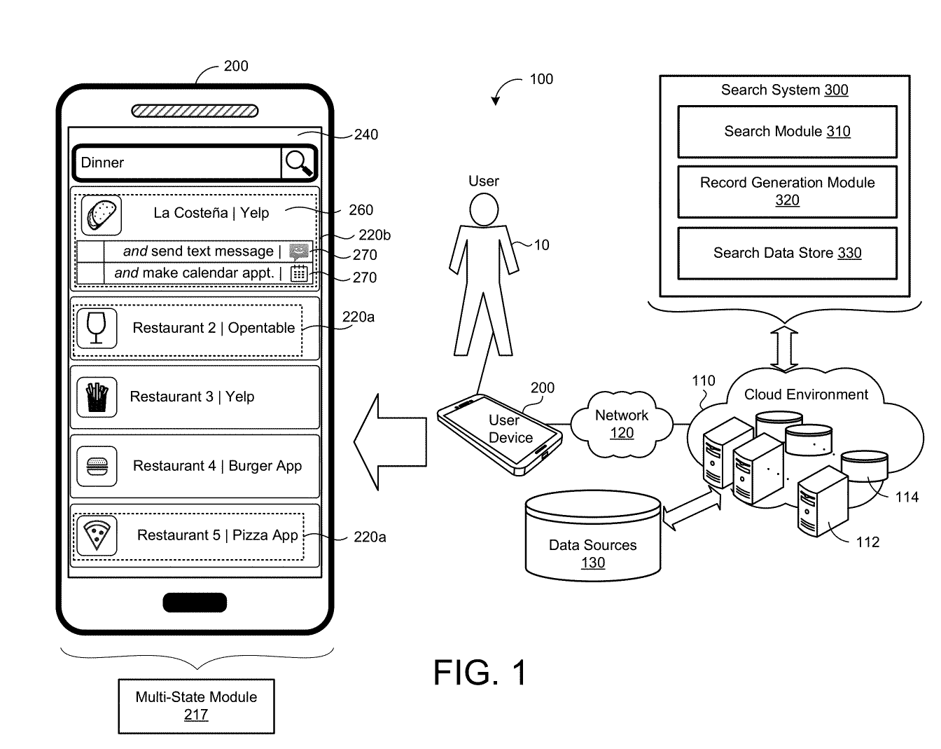

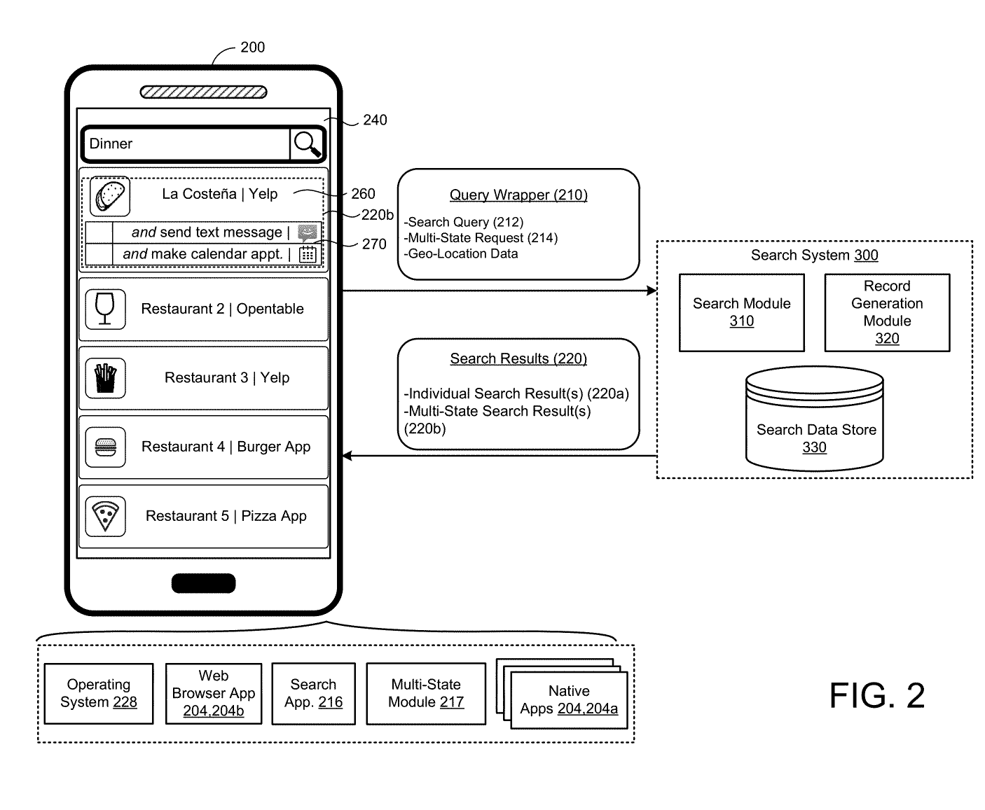

FIGS. 1 and 2 illustrate an example environment 100 including a search system 300 and a user device 200. The user device 200 may include a search application 216 in which a user 10 can enter a search query 212 into a text box. The search application 216 may be configured to execute a multi-state module 217 (discussed in detail below). The multi-state module 217 may include a multi-state request 214 in the query wrapper 210. The user device 200 may transmit a query wrapper 210 including the search query 212 and a multi-state request 214 to the search system 300. A multi-state request 214 may be data indicating that the user device 200 requests multi-state results 220b to be included in the search results 220. In this way, the search system 300 may avoid transmitting a multi-state result 220b to a user device incapable of handling (e.g., rendering and displaying) a multi-state result 220b. Additionally or alternatively, a user may configure the multi-state module 217 to request and launch multi-state results according to the user's preferences (e.g., the user may configure the multi-state module 217 to include a multi-state request with every search query 212). In some implementations, a multi-state request 214 may specify a number of multi-state results 220b (e.g., a request for three multi-state results 220b).

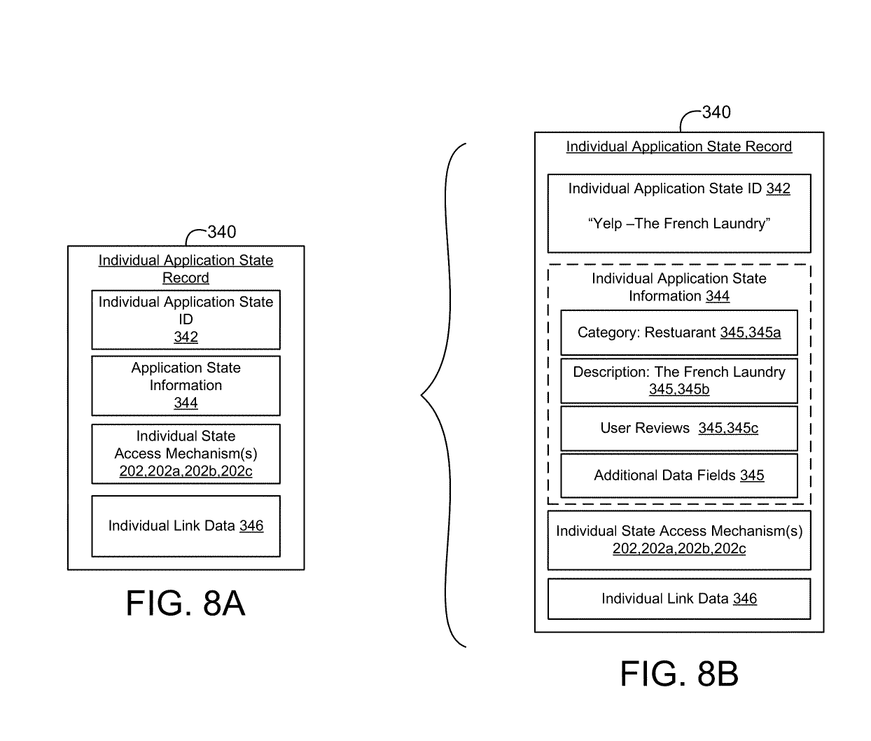

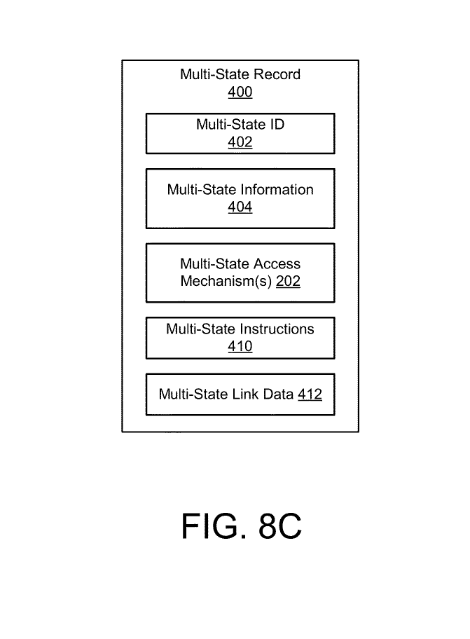

The search system 300 transmits search results 220 to the user device 200 in response to a received query wrapper 210. The search results 220 can include individual search results 220a and one or more multi-state search results 220b. The search system 300 may generate multi-state search results 220b based on one or more multi-state records 400 (FIG. 8C) stored in the search data store. The multi-state records 400 may be generated using the record generation module 320 automatically or manually with the assistance of a system operator (discussed in more detail herein). A multi-state search result 220b may include multi-state instructions 410, one or more access mechanisms, and any additional data (e.g., text and images) that may be used to render and display the multi-state search result 220b as a user-selectable link. The search application 216 may display the received search results 220 as user-selectable links within a graphical user interface (hereafter “GUI”) 240 with which the user may interact.

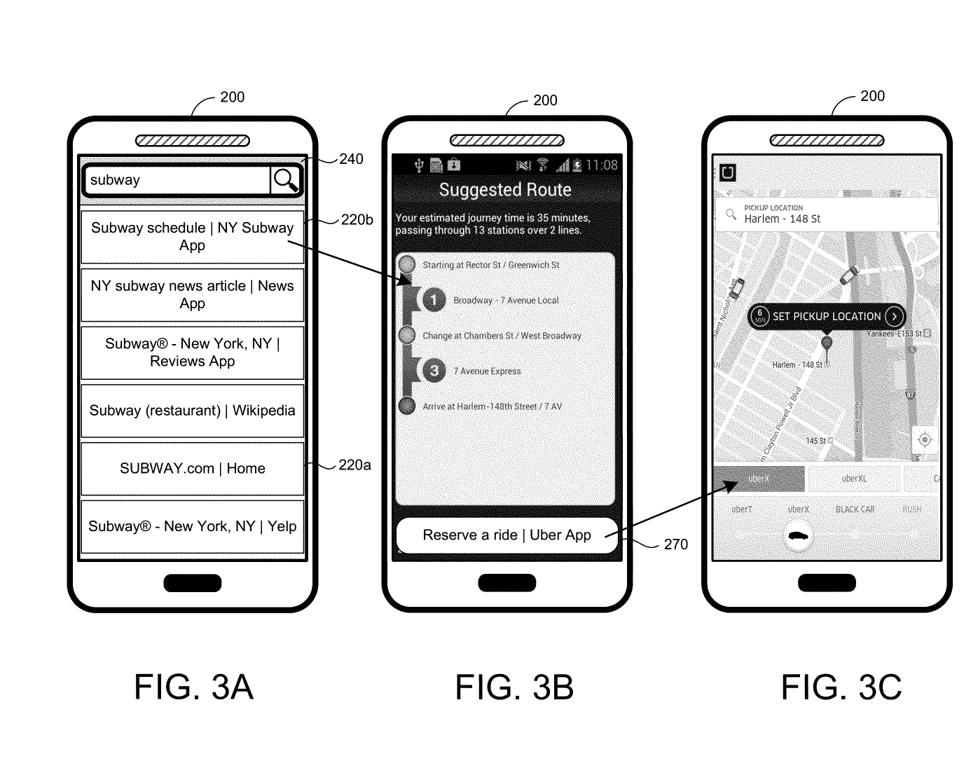

The search application 216 may display the multi-state search results 220b (hereafter “multi-state results” 220b) in a search engine results page (hereafter “SERP”) in a variety of different ways. In some implementations, the search application 216 may display the multi-state results 220b in the same manner as the individual search results 220a (hereafter “individual results” 220a). For example, the search application 216 may display the multi-state results 220b and individual results 220a as user-selectable links indicating an application state that may launch in response to selection of the link (see, e.g., FIG. 3A). If a user selects a multi-state result 220b, the multi-state module 217 may cause the user device 200 to launch the primary application state 260 associated with the multi-state result 220b. In this example, the multi-state module 217 may include user-selectable links to secondary application states 270 within the launched primary application state 260 and any subsequently launched secondary states 270 (see, e.g., FIG. 3B).

In some implementations, the search application 216 may display the multi-state search results 220b in a different manner than the individual search results 220a. In one example, the displayed multi-state search results 220b may indicate (e.g., using text and images) which additional application states will be opened upon selection (e.g., via a user click or touch) of the multi-state result 220b. The displayed multi-state results 220b may additionally or alternatively be configured to indicate the order in which the application states will be opened (e.g., the order in which the secondary states 270 will be launched after the primary state 260 is launched). In another example, a displayed multi-state search result 220b may also include text or images indicating whether selection of the multi-state result 220b will cause its corresponding application states to launch sequentially or in parallel.

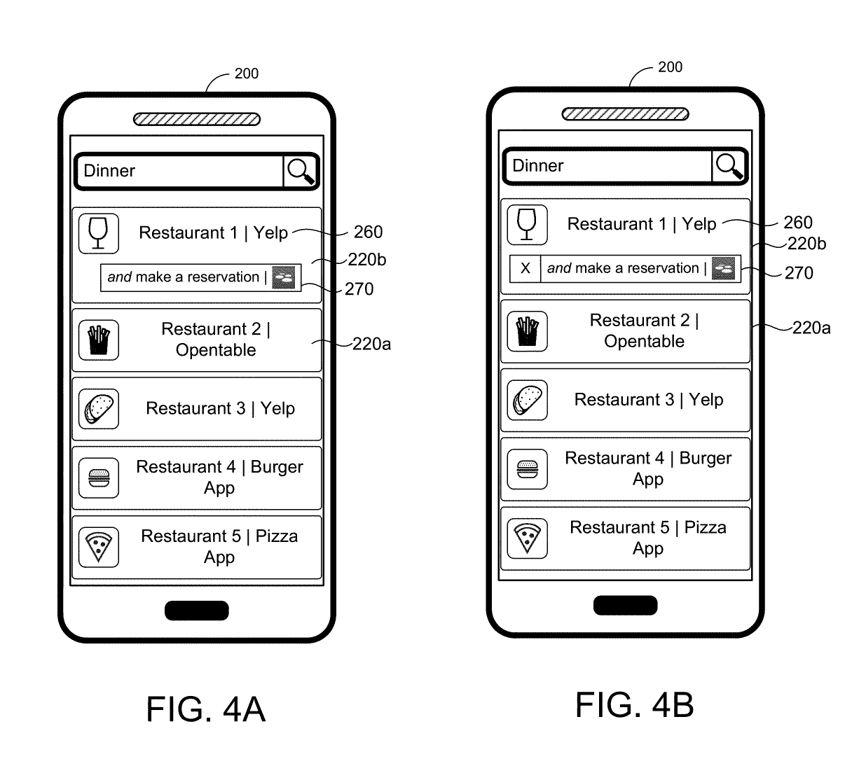

In some implementations, the multi-state results 220b may be displayed in a manner indicating that the displayed multi-state result 220b can accept input or otherwise be configured by a user. In some implementations, a user may select which secondary application states 270 of a multi-state result 220b will be launched upon selection of the displayed multi-state result 220b. For example, FIG. 4B depicts a displayed multi-state search result 220b that provides a user-selectable link to the business review application YELP® (developed by Yelp, Inc.). In this example, the multi-state module 217 may include an interface element in the form of a checkbox corresponding to a secondary application state 270, whereby a user may select or deselect the checkbox. If a user selects the interface element (e.g., by touching or clicking on the checkbox), the user device 200 will additionally launch the corresponding secondary application state 270, which in this case is a state of the restaurant reservation application OPENTABLE® (developed by OpenTable, Inc.). In this example, a user may also deselect the interface element (e.g., by touching or clicking on the checkbox after it has been selected), thereby precluding the user device 200 from launching the additional state indicated by the displayed multi-state result 220b. In these implementations, the multi-state module 217 may include more checkboxes corresponding to other secondary application states 270 of the multi-state result 220b. In some implementations, the multi-state module 217 may additionally include interface elements that allow a user to select how a multi-state result 220b will be launched. For example, the multi-state module 217 may provide interface elements that allow a user to select whether to launch the secondary application states 270 indicated by a multi-state result 220b sequentially or in parallel.

In some implementation, a multi-state result 220b may be displayed in a manner that does not accept input or configuration from a user aside from selection of the link. For example, as depicted by FIG. 4A, a displayed multi-state result 220b may use non-interactive text/images to indicate to a user 10 which application states may be launched by the user device 200 upon selection of the displayed multi-state result 220b. In this example, the user 10 may not select additional secondary states 270 or determine whether the secondary application states 270 will be launched sequentially or in parallel.

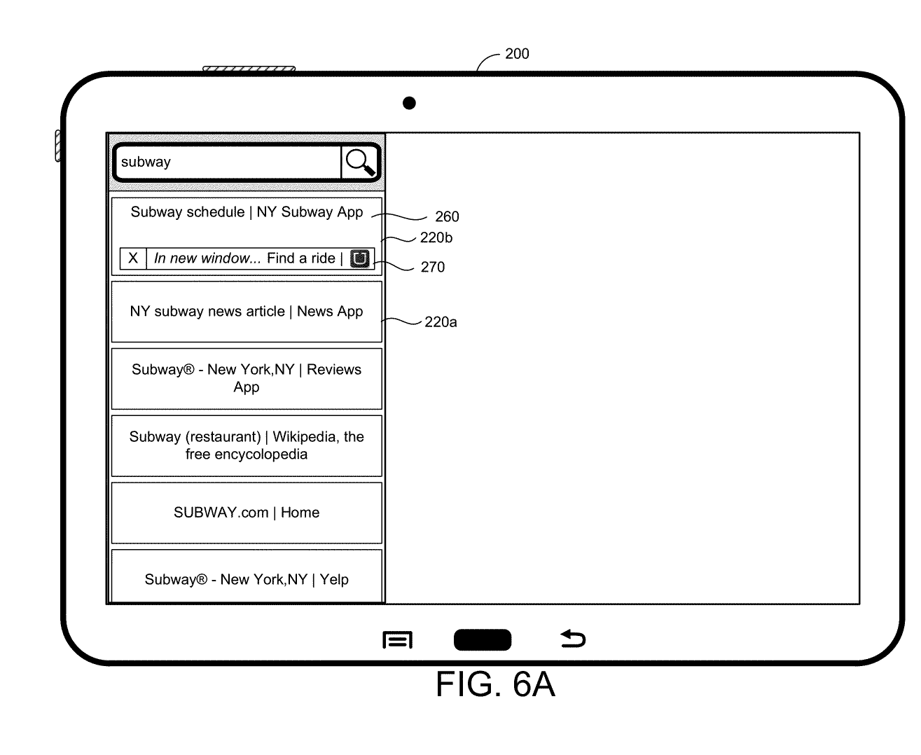

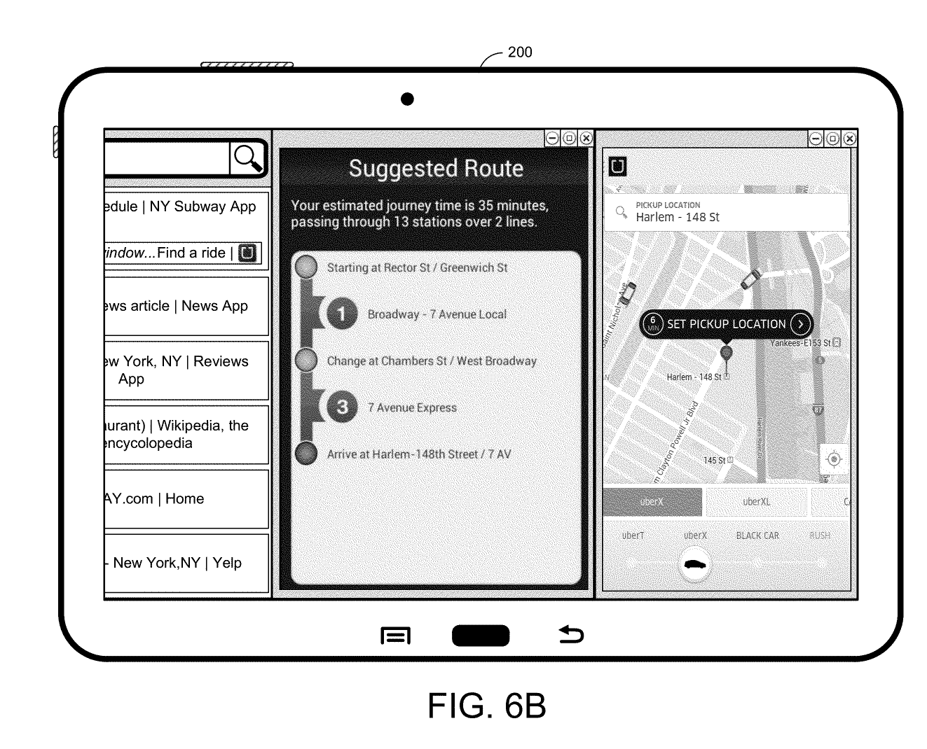

The user device 200 (e.g., via the multi-state module 217) may respond to a user's selection of a displayed multi-state result 220b in several ways. In some implementations, the user device 200 may launch application states associated with a multi-state result 220b in parallel. For example, the user device 200 may launch the primary application state 260 and a secondary application state 270 associated with the selected multi-state result 220b simultaneously. In the case where the user device 200 is configured to display one launched application state at a time (e.g., in the case of a smaller display on a phone device), one or more of the secondary application states 270 may be launched and running in the background. In this case, the user 10 may alternate between the two application states launched in parallel. In the case where a user device 200 includes a larger display (e.g., a tablet, laptop, or desktop device), the user device 200 may display the application states adjacent to each other. FIG. 6B, discussed in more detail below, provides an illustration of an example user device 200 launching applications in parallel. As depicted by FIG. 6B, the user device may launch a public transportation application in a window adjacent to the search application 216 and set it to a state displaying a suggested route. The user device may additionally launch a transportation application, such as UBER® (developed by Uber, Inc.), in another adjacent window and set it to a state displaying a map of pickup locations.

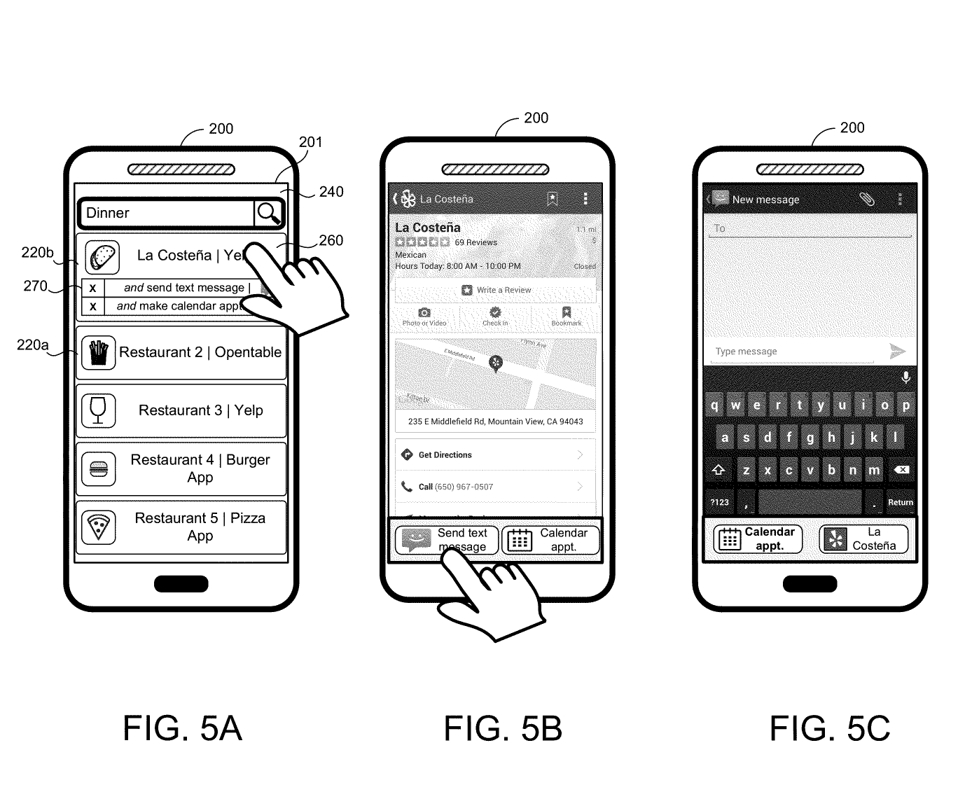

In some implementations, the user device 200 (e.g., via the multi-state module 217) may launch application states in a sequence (e.g., one application state at a time). In one example, the sequence in which secondary application states 270 are launched may be determined by a user of the user device 200. More specifically, upon selection of a multi-state result 220b, the user device 200 may initially launch the primary application state 260. The user device 200 may then render links to subsequent secondary application states 270 within or adjacent to the primary application state 260 (see, e.g., FIG. 3B). The user device 200 may then launch a secondary application state 270 upon user selection of a corresponding link. In this example, the newly launched secondary application state 270 may also include links based on the multi-state result 220b, such as links to other secondary application states 270 or back to the primary application state 260. In this example, the sequence depends on the order in which a user selects links to the one or more secondary application states 270. A native application 204a may be configured to execute a multi-state module 217. In this way, a native application 204 may render and display links within its application states to subsequent secondary states 270 based on data included in a multi-state search result 220b (e.g., multi-state instructions 410 and access mechanisms 202). In some implementations, a separately executing program (e.g., a launcher program executing separately from the search application 216) may be configured to implement the multi-state module 217. In this way, a launcher installed on the user device 200 may render links to the subsequent secondary states 270 based on data included in a multi-state search result 220b. For example, the multi-state module 217 may cause the launcher to display a graphical overlay, thereby providing user-selectable links to one or more secondary states 270 from within the primary state 260 or another secondary state 270 (see, e.g., FIGS. 5B-5C).

In another example, the user device 200 may automatically launch one or more secondary application states 270 according to multi-state instructions 410 included in the multi-state search result 220b. The user device 200 may automatically launch subsequent secondary states 270 in response to a variety of different triggers indicated by the multi-state instructions 410. In some examples, the user device 200 may transition to a secondary application state 270 in response to a user completing an action (e.g., reserving a table or making a purchase). In other examples, the transition may be set to occur upon reaching a predefined state in the application that was initially launched (e.g., the state of viewing the last photograph in a set of photographs provided by the launched application). In other examples, the transition to a subsequent state may occur after a predetermined period of time has elapsed.

Any of the parallel and sequential launch and display techniques discussed herein may be combined or used separately. For example, a multi-state module 217 may cause three applications to launch in parallel, whereby each application launched in parallel additionally includes links to subsequent secondary application states 270. This disclosure contemplates any reasonable manner of launching and displaying multiple application states. The data related to launching and displaying one or more application states sequentially or in parallel (e.g., the triggers for opening a subsequent application state, the order in which application states should be opened, and whether the multi-state result 220b may accept user input) may be included in the multi-state instructions 410 of a corresponding multi-state record 400.

FIG. 2 illustrates an example user device 200 in communication with the search system 300. The user device 200 transmits a query wrapper 210 to the search system 300. The query wrapper may include a request for multi-state results 220b. The multi-state request 214 may indicate that the device can handle multi-state results 220b and/or that the user has indicated a desire to receive multi-state results 220b.

The user device 200 may include a multi-state module 217. The multi-state module 217 represents functionality on the user device 200 that handles the received multi-state search result 220b. A list of example functionality that may be attributed to a multi-state module 217 may include, but is not limited to, the following: rendering and displaying multi-state results 220b in a GUI, launching applications referenced in a multi-state result 220b, accepting user input related to a multi-state result 220b, and instructing a native application or the operating system to perform operations related to a multi-state result 220b. The multi-state module 217 may be included in the search application 216 or be a stand-alone application (e.g., a launcher program). In some examples, functionality of the multi-state module 217 described herein may be included in individual native applications so that individual native applications may render and display multi-state results 220b as links within the applications and perform other features for implementing the techniques of the present disclosure.

As described herein, a multi-state module 217 may be executed by a native application, a launcher program, and/or the operating system of the user device 200. The multi-state module 217 may accept settings from a user with regard to the manner in which multi-state results 220b should be requested and with regard to how application states corresponding to the multi-state results 220b should be rendered and displayed by the user device 200. For example, a user may configure a multi-state module 217 executing on a search application 216 to request at least one multi-state result 220b with each search query 212. In another example, a user may configure a multi-state module 217 executing separately from any native applications 204 on the user device 200 (e.g., in the case where the multi-state module is executed by a launcher) to launch application states associated with multi-state results in parallel, but not sequentially. In some implementations, a multi-state module 217 may not accept settings from a user with regard to the request and handling of multi-state results 220b. For example, a multi-state module 217 executing on a search application 216 may include multi-state result requests 214 with a pre-designated list of search queries and not allow a user device to request multi-state results 220b in other circumstances.

FIG. 2 illustrates an example a multi-state result 220b with which a user 10 may interact. More specifically, the user 10 may interact with (e.g., touch) the boxes to the left of the indicated secondary states 270 (a state of a text message application 204 and a state of a calendar application 204). The user 10 may select the multi-state result 220b by touching the displayed multi-state result 220b. If the user 10 interacts with one or more of the interface elements corresponding to the secondary states 270 (e.g., by touching a checkbox), then the selected secondary states 270 may be launched as described herein (e.g., sequentially or in parallel). If the user 10 does not select any secondary states 270, then the user device 200 may only launch the primary application state 260 of the YELP® application related to a restaurant called “La Costeña.”

In some implementations, in contrast to FIG. 2, a multi-state result 220b may not appear any different than an individual result 220a (e.g., the multi-state result 220b may not include any text and/or images describing secondary application states 270), but may still launch secondary application states 270 upon user selection (e.g., sequentially or in parallel as described herein). In some implementations, a multi-state result 220b may include text and/or images indicating secondary states 270 that may launch upon selection of the multi-state result 220b, but may not allow a user to select which of the secondary states 270 will launch.

FIGS. 3A-3C illustrate an example user device 200 launching secondary application states 270 sequentially upon user selection of a multi-state result 220b. FIGS. 3A-3C additionally provide an example of a multi-state module 217 executing from within a search application and a public transportation application. In this way, a multi-state module 217 may include links to subsequent secondary states 270 within primary 260 and secondary application states 270. FIG. 3A shows an example list of search results 220, the first of which is a displayed multi-state result 220b entitled “Subway schedule|NY Subway App.” The displayed multi-state result 220b does not provide any indication (e.g., text/images) that the result is a multi-state result 220. The user device 200 may launch the primary application state 260 (FIG. 3B) in response to user selection of the displayed multi-state result 220b. The launched primary application state 260 includes a link to a subsequent secondary state 270 (FIG. 3B). In this example, the multi-state module 217 may execute as a part of a native application (e.g., the NY Subway App) in order to include multi-state results 220b within the application states of the native application.

FIG. 4A depicts an example displayed multi-state result 220b with which a user 10 may not interact. The displayed multi-state result 220b causes the user device 200 to launch the YELP® application to a state related to “Restaurant 1.” In this example, the displayed multi-state result 220b indicates that the restaurant reservation application, OPENTABLE® will, at some point (e.g., sequentially or in parallel) be launched in response to user selection of the multi-state result 220b. FIG. 4B depicts a multi-state result 220b to the same primary application state 260 and secondary application state 270 as the multi-state result 220b of FIG. 4A. However, in contrast to FIG. 4A, the multi-state result 220b of FIG. 4B includes a user interface element in the form of a checkbox that allows a user to select/deselect a subsequent or parallel secondary state 270. In FIG. 4B, the user can select the secondary result 270 by touching the checkbox, thereby causing the user device to launch the OPENTABLE® application to a state that allows the user to make a reservation for Restaurant 1. The user may also deselect the secondary state 270 indicated by the multi-state result 220b, thereby precluding the user device 200 from launching the deselected secondary state 270. It bears noting that the secondary state 270 may be launched sequentially or in parallel to the current search application 212 executing on the user device 200 and the primary application state 260.

FIGS. 5A-5C depict a user device 200 launching secondary application states 270 sequentially. In this example, the multi-state module 217 may execute as part of both a launcher program and a search application 216. The example displayed multi-state result 220b of FIG. 5A indicates to a user that it is a multi-state result 220b by incorporating interface elements that allow a user to select which secondary states 270 will be launched in sequentially.

In FIG. 5A, the user has selected the secondary states 270 for a text messaging application and a calendar application indicated by the displayed multi-state result. The user has also selected (e.g., touched) the search result card for an application state of the YELP® application related to a restaurant called “La Costeña.” In response to the user's selection, the multi-state module 217 may cause the user device to open the corresponding application state of the YELP® application. At FIG. 5B, the multi-state module 217 (e.g., via a launcher program separate from the search application 216 and the YELP® application) may then render user-selectable links to the previously selected secondary states 270 in an overlay at the bottom of a screen 201. Though in the depicted at the bottom of the screen in FIG. 5B, the graphical overlay may appear at any other location on the screen, such as the sides or top of the screen.

In FIG. 5B, the user selects a link to a secondary state 270 (e.g., a state of a text messaging application) which causes the user device 200 to launch the text messaging application. As depicted by FIG. 5C, the multi-state module 217 (e.g., via the launcher) may then render and display an overlay including a link to another secondary state 270 (e.g., a state of a calendar application) and a link to the primary state 260 (e.g., the state of the YELP® application related to La Costeña) within the state of the text messaging application.

FIGS. 6A-6B illustrate an example user device 200 launching multiple application states (e.g., a primary application state 260 and one or more secondary application states 270) associated with a multi-state result 220b in parallel. FIG. 6A depicts a search application 216 GUI including a multi-state search result 220b. The multi-state search result 220b includes a secondary link 270 that may be selected by a user. The secondary link 270 indicates that a secondary application state for finding a ride in the UBER® transportation application will be launched in parallel with the subway schedule for the NY Subway App.

FIG. 6B shows an example GUI 240 generated on the user device 200 after the user 10 selected the secondary link 270 and then selected the multi-state search result 220b. In FIG. 6B, both the NY Subway Application and the UBER® application have been launched in parallel on the user device 200. The user device 200 illustrated may be a tablet/laptop device having a larger display than a typical handheld device (e.g., cell phone device). Accordingly, GUIs for both of the applications may be satisfactorily displayed at the same time on the user device 200. Although the search application 216 is illustrated as being open (e.g., by appearing partially onscreen) at the same time as the NY Subway Application and the UBER® application, it is contemplated that, in some implementations, selection of the multi-state search result 220b may cause the search application 216 to disappear such that only the NY Subway Application and the UBER® application are displayed after selection of the multi-state result. Although both application states opened in parallel are displayed onscreen at the same time in FIG. 6B, in other implementations, both application states may be opened in parallel, but displayed at different times. For example, in the scenario where the user device 200 is a smaller device such as a phone device, the secondary application states 270 may be launched simultaneously but running in the background.

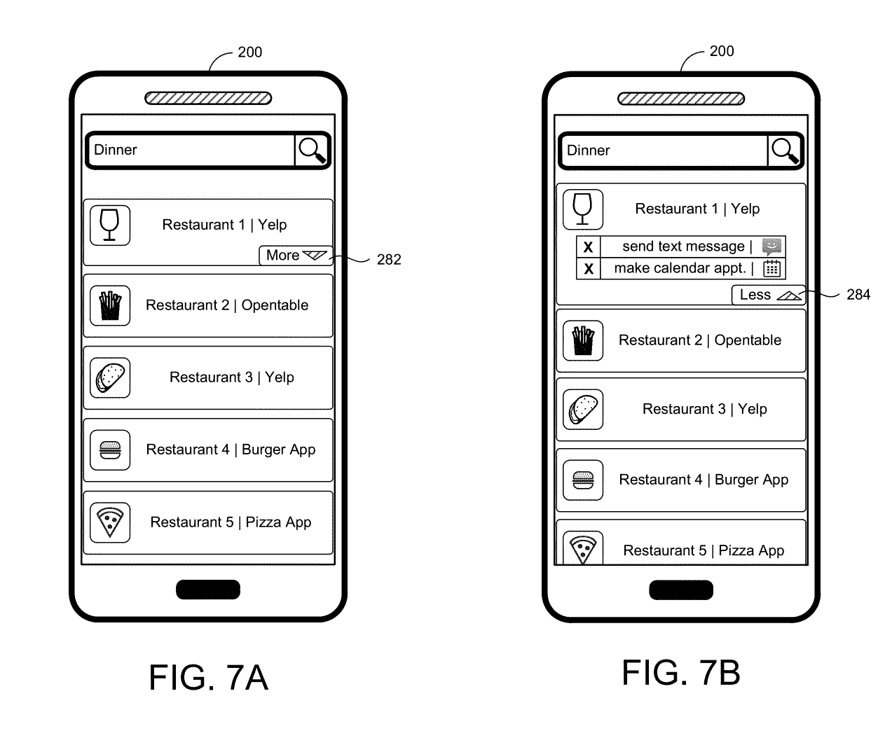

FIGS. 7A-7B illustrate a GUI 240 feature that may be implemented by a multi-state module 217, whereby secondary results 270 of a multi-state result 220b are initially concealed in a SERP. However, the presence of secondary results 270 is indicated in the GUI by the interface element 282 labeled “More”. FIG. 7B shows an example response of the GUI 240 to the selection of the “More” interface element. Specifically, the secondary links 270 are rendered in the multi-state result 220b in response to the selection of the “More” interface element 282. Selection of the “Less” interface element 284 in FIG. 7B may conceal the secondary links 270 of FIG. 7B so that the GUI returns to the state of FIG. 7A.

Referring back to FIG. 1, the data sources 130 may be sources of data, which the search system 300 (e.g., the search module 310 and record generation module 320) may use to generate and update the search data store 330. The data retrieved from the data sources 130 can include any type of data related to application functionality and/or application states. Data retrieved from the data sources 130 may be used to create and/or update one or more databases, indices, tables (e.g., an access table), files, or other data structures included in the search data store 330. For example, application state records 340 and multi-state records 400 may be created and updated based on data retrieved from the data sources 130. In some examples, some data included in the data store 330 may be manually generated by a human operator. Data included in the application state records 340 and multi-state records 400 may be updated over time so that the search system 300 provides up-to-date results.

The data sources 130 may include a variety of different data providers. The data sources 130 may include data from application developers, such as application developers' websites and data feeds provided by developers. The data sources 130 may include operators of digital distribution platforms configured to distribute native applications 204 to user devices 200. Example digital distribution platforms include, but are not limited to, the GOOGLE PLAY® digital distribution platform by Google, Inc. and the APP STORE® digital distribution platform by Apple, Inc.

The data sources 130 may also include other websites, such as websites that include web logs (i.e., blogs), application review websites, or other websites including data related to applications. Additionally, the data sources 130 may include social networking sites, such as “FACEBOOK®” by Facebook, Inc. (e.g., Facebook posts) and “TWITTER®” by Twitter Inc. (e.g., text from tweets). Data sources 130 may also include online databases that include, but are not limited to, data related to movies, television programs, music, and restaurants. Data sources 130 may also include additional types of data sources in addition to the data sources described above. Different data sources 130 may have their own content and update rate.

Referring to FIGS. 8A and 8B, the search data store 330 includes a plurality of different application state records 340 and multi-state records 400 (discussed below with respect to FIG. 8C). Each application state record 340 may include data related to a function of an application 204 and/or the state of the application 204 resulting from performance of the function. An application state record 340 may include an application state identifier (ID) 342, application state information 344, one or more access mechanisms 202, 202a, 202b, 202c used to access functionality provided by an application 204, associated state actions (s) 346, and associated entity identification.

The application state ID 342 may be used to identify the application state record 340 among the other application state records 340 included in the search data store 330. The application state ID 342 may be a string of alphabetic, numeric, and/or symbolic characters (e.g., punctuation marks) that uniquely identifies the associated application state record 340. In some examples, the application state ID 342 describes a function and/or an application state in human readable form. For example, the application state ID 342 may include the name of the application 204 referenced in the access mechanism(s) 202. In a specific example, an application state ID 342 for an internet music player application may include the name of the internet music player application along with the song name that will be played when the internet music player application is set into the state defined by the application access mechanism included in the function record. Additionally or alternatively, the application state ID 342 may be a human readable string that describes a function performed according to the access mechanism(s) 202 and/or an application state resulting from performance of the function according to the access mechanism(s) 202. In some examples, the application state ID 342 includes a string in the format of a uniform resource locator (URL) of a web access mechanism 202b for the application state record 340, which may uniquely identify the application state record 340.

In a more specific example (FIG. 8B), if the application state record 340 describes a function of the YELP® native application 204a, the application state ID 342 may include the name “Yelp” along with a description of the application state described in the application state information 344. For example, the application state ID 342 for an application state record 340 that describes the restaurant named “The French Laundry” may be “Yelp—The French Laundry.” In an example where the application state ID 342 includes a string in the format of a URL, the application state ID 342 may include the following string “http://www.yelp.com/biz/the-french-laundry-yountville-2?ob=1” to uniquely identify the application state record 340. In additional examples, the application state ID 342 may include a URL using a namespace other than “http://,” such as “func://,” which may indicate that the URL is being used as a function ID in a function record. For example, the application state ID 342 may include the following string “func://www.yelp.com/biz/the-french-laundry-yountville-2?ob=1.”

The application state information 344 may include data that describes an application state into which an application 204 is set according to the access mechanism(s) 202 in the application state record 340. Additionally or alternatively, the application state information 344 may include data that describes the function performed according to the access mechanism(s) 202 included in the application state record 340. The application state information 344 can include text, numbers, and symbols that describe the application state. The types of data included in the application state information 344 may depend on the type of information associated with the application state and the functionality specified by the application access mechanism 202a. The application state information 344 may include a variety of different types of data, such as structured, semi-structured, and/or unstructured data. The application state information 344 may be automatically and/or manually generated based on documents retrieved from the data sources 130. Moreover, the application state information 344 may be updated so that up-to-date search results 220 can be provided in response to a search query 212.

In some examples, the application state information 344 includes data that may be presented to the user 10 by an application 204 when the application 204 is set in the application state defined by the access mechanism(s) 202. For example, if one of the access mechanism(s) 202 is an application access mechanism 202a, the application state information 344 may include data that describes a state of the native application 204a after the user device 200 has performed the one or more operations indicated in the application access mechanism 202a. For example, if the application state record 340 is associated with a shopping application, the application state information 344 may include data that describes products (e.g., names and prices) that are shown when the shopping application is set to the application state defined by the access mechanism(s) 202. As another example, if the application state record 340 is associated with a music player application, the application state information 344 may include data that describes a song (e.g., name and artist) that is played when the music player application is set to the application state defined by the access mechanism(s) 202.

The types of data included in the application state information 344 may depend on the type of information associated with the application state and the functionality defined by the access mechanism(s) 202. For example, if the application state record 340 is for an application 204 that provides reviews of restaurants, the application state information 344 may include information (e.g., text and numbers) related to a restaurant, such as a category of the restaurant, reviews of the restaurant, and a menu for the restaurant. In this example, the access mechanism(s) 202 may cause the application 204 (e.g., a native application 204a or a web-browser application 204b) to launch and retrieve information for the restaurant. As another example, if the application state record 340 is for an application 204 that plays music, the application state information 344 may include information related to a song, such as the name of the song, the artist, lyrics, and listener reviews. In this example, the access mechanism(s) 202 may cause the application 204 to launch and play the song described in the application state information 344.

The search system 300 may generate application state information 344 included in an application state record 340 in a variety of different ways. In some examples, the search system 300 retrieves data to be included in the application state information 344 via partnerships with database owners and developers of native applications 204a. For example, the search system 300 may automatically retrieve the data from online databases that include, but are not limited to, data related to movies, television programs, music, and restaurants. In some examples, a human operator manually generates some data included in the application state information 344. The search system 300 may update data included in the application state information 344 over time so that the search system 300 provides up-to-date search results 220.

An application state record 340 including an application access mechanism 202 that causes an application 204 to launch into a default state may include application state information 344 describing the native application 204a, instead of any particular application state. For example, the application state information 344 may include the name of the developer of the application 204, the publisher of the application 204, a category 345a (e.g., genre) of the application 204, a description 345b of the application 204 (e.g., a developer's description), and the price of the application 204. The application state information 344 may also include security or privacy data about the application 204, battery usage of the application 204, and bandwidth usage of the application 204. The application state information 344 may also include application statistics. Application statistics may refer to numerical data related to a native application 204a. For example, application statistics may include, but are not limited to, a number of downloads, a download rate (e.g., downloads per month), a number of ratings, and a number of reviews.

The example application state information 344 includes data fields 345, such as a category 345a of THE FRENCH LAUNDRY® restaurant, a description 345b of THE FRENCH LAUNDRY® restaurant, user reviews 345c of THE FRENCH LAUNDRY® restaurant, and additional data fields 345. The restaurant category 345a field may include the text “French cuisine” and “contemporary,” for example. The description field 345b may include text that describes THE FRENCH LAUNDRY® restaurant. The user reviews field 345c may include text of user reviews for THE FRENCH LAUNDRY® restaurant. The additional data fields 345 may include additional data for THE FRENCH LAUNDRY® restaurant that may not specifically fit within the other defined fields, such as a menu for the restaurant, prices, and operating hours for the restaurant.

The associated state action(s) 346 identifies an operation or action of each one of the application access mechanism(s) of the application state record 340. For example, if the application state record 340 is for an application that provides restaurant reviews, then the associated state action 346 is “Review Business.” As another example, if the application state record 340 is for an application that provides direction to a location, then the associated state action 346 is “Navigate To.” As an example shown in FIG. 3D, the associated state actions(s) 346 for the application state record 340 of the Yelp application may be ‘make restaurant reservations,’ ‘find taxi,’ and ‘navigate to.’

In some implementations, an application state record 340 includes multiple different application access mechanisms 202, 202a, 202b, 202c that may include a variety of information. The application access mechanism 202 may include edition information that indicates the application edition with which the application access mechanism 202 is compatible. For example, the edition information may indicate the operating system 228 with which the application access mechanism 202 is compatible. Moreover, different application access mechanisms 202 may be associated with different editions of a native application 204a. A native application edition (hereinafter “application edition”) refers to a particular implementation or variation of a native application 204a. For example, an application edition may refer to a version of a native application 204a, such as a version 1.0 of a native application 204a or a version 2.0 of a native application 204a. In another example, an application edition may refer to an implementation of a native application 204a for a specific platform, such as a specific operating system 228.

The different application access mechanisms 202 included in an application state record 340 may cause the corresponding application editions to launch and perform similar functions. Accordingly, the different application access mechanisms 202 included in an application state record 340 may cause the corresponding application editions to be set into similar application states. For example, if the different application access mechanisms 202 reference different editions of an information retrieval application, the different application access mechanisms 202 may cause the corresponding application editions to retrieve similar information. In another example, if the different application access mechanisms 202 reference different editions of an internet music player application, the different application access mechanisms 202 may cause the corresponding application editions to play the same song.

In some examples, an application state record 340 for a native application 204a that retrieves restaurant information may include multiple different application access mechanisms 202 for multiple different application editions. Assuming the application state record 340 is associated with a specific Mexican restaurant, the application access mechanisms 202 for the different application editions may cause each application edition to retrieve information for the same specific Mexican restaurant. For example, a first application access mechanism 202 may cause a first application edition (e.g., on a first OS) to retrieve information for the specific Mexican restaurant. A second application access mechanism 202 may cause a second application edition (e.g., on a second OS) to retrieve information for the specific Mexican restaurant. In some examples, the search system 300 can determine whether to transmit the application access mechanism 202 in the search results 220 based on whether the user device 200 can handle the application access mechanism 202.

A user device 200 can access a state of a software application via an edition of the software application using an access mechanism. When rendering a user selectable link a user device 200 displays the user selectable link such that can be selected by a user of the user device 200. A user selectable link may include one or more underlying access mechanisms. A user selectable link, when selected by a user, causes the user device 200 to access a state of the software application using an edition of the software application identified by the access mechanism.

Access mechanisms may include at least one of a native application access mechanism (referred to herein as “application access mechanism”), a web access mechanism, and an application download mechanism. The user device 200 may use the access mechanisms to access functionality of applications. For example, the user may select a user selectable link including an access mechanism in order to access functionality of an application indicated in the user selectable link. As described herein, the deep-linking system may transmit one or more application access mechanisms, one or more web access mechanisms, and one or more application download mechanisms to the user device 200 in the search results 220 (e.g., the individual results 220a and multi-state results 220b).

An application access mechanism may be a string that includes a reference to a native application (e.g., one of native applications 204 installed on the user device 200) and indicates one or more operations for the user device 200 to perform. If a user selects a user selectable link including an application access mechanism, the user device 200 may launch the native application referenced in the application access mechanism and perform the one or more operations indicated in the application access mechanism.

A web access mechanism may include a resource identifier that includes a reference to a web resource (e.g., a page of a web application/website). For example, a web access mechanism may include a uniform resource locator (URL) (i.e., a web address) used with hypertext transfer protocol (HTTP). If a user selects a user selectable link including a web access mechanism, the user device 200 may launch the web browser application and retrieve the web resource indicated in the resource identifier. Put another way, if a user selects a user selectable link including a web access mechanism, the user device 200 may launch the web browser application 216 and access a state (e.g., a page) of a web application/website. In some examples, web access mechanisms may include URLs for mobile-optimized sites and/or full sites. In some implementations described herein, a multi-state module 217 may operate as a part of a web browser application 204b. In this way, the multi-state module 217 may handle multi-state results 220b that are associated with websites. For example, if a multi-state result 220b indicates a state of a web-based application or website, the multi-state module 217 executing on the web browser application 204b may implement the functionality (e.g., displaying links to primary and secondary application states 260, 270) described herein.

An application download mechanism may indicate a site (e.g., a digital distribution platform) where a native application can be downloaded in the scenario where the native application is not installed on the user device 200. If a user selects a user selectable link including an application download address, the user device 200 may access a digital distribution platform from which the referenced native application may be downloaded. The user device 200 may access a digital distribution platform using at least one of the web browser application 216 and one of the native applications 204a.

FIG. 8C illustrates an example multi-state record 400. The multi-state record may include a multi-state ID 402. The multi-state ID 402 may be a string, number, symbol, or any other value that may be used to uniquely identify the multi-state record 400 from other multi-state records 400. The multi-state record 400 may include multiple access mechanisms 202, each access mechanism corresponding to a different application state accessible according to the multi-state instructions 410. The multi-state record 400 may also include multi-state information 404, which may be text and other attributes that may be used to locate the multi-state record 400 during a search. The information may describe the states accessed by the multi-state access mechanisms 202, such as the actions performed in response to launching an application state according to the multi-state access mechanisms 202.

The record 400 may additionally include multi-state instructions 410. The multi-state instructions 410 may be utilized by a user device 200 (e.g., via a multi-state module 217) to access the application states corresponding to the multi-state access mechanisms 202. For example, the multi-state instructions 410 may indicate the order in which the applications corresponding to the multi-state access mechanisms 202 are to be launched. As another example, the multi-state instructions 410 may indicate whether to display the application states sequentially (e.g., display new application state(s) in response to a trigger) or in parallel (e.g., open multiple windows in the GUI, whereby each window displays the content of a different application state). The record 400 also includes multi-state link data 410 that the user device 200 can use to render the displayed multi-state results 220b and subsequent links.

In some examples, the multi-state instructions 410 indicate how to render the primary and secondary links in the search result page (SERP), such as the location and layout of the links in the SERP. Moreover, the multi-state instructions 410 may describe how to include links to primary and secondary states 260, 270 within a current application state (e.g., in the case where the current application executes at least a part of the multi-state module's 217 functionality). The multi-state instructions may include instructions for rendering subsequent links, such as whether to render the links in a launcher program or whether a native application should render the links. The multi-state instructions may also indicate the trigger conditions for launching a subsequent state. The trigger conditions may include detection of a user input (e.g., detection of a user selecting a subsequent link), detection of an action (such as a user completing a restaurant reservation), detection of geo-location data (such as a zip code), or the detection of an application entering a state (e.g., upon entering or leaving an application state). In some examples, the multi-state instructions include a hard-coded program.

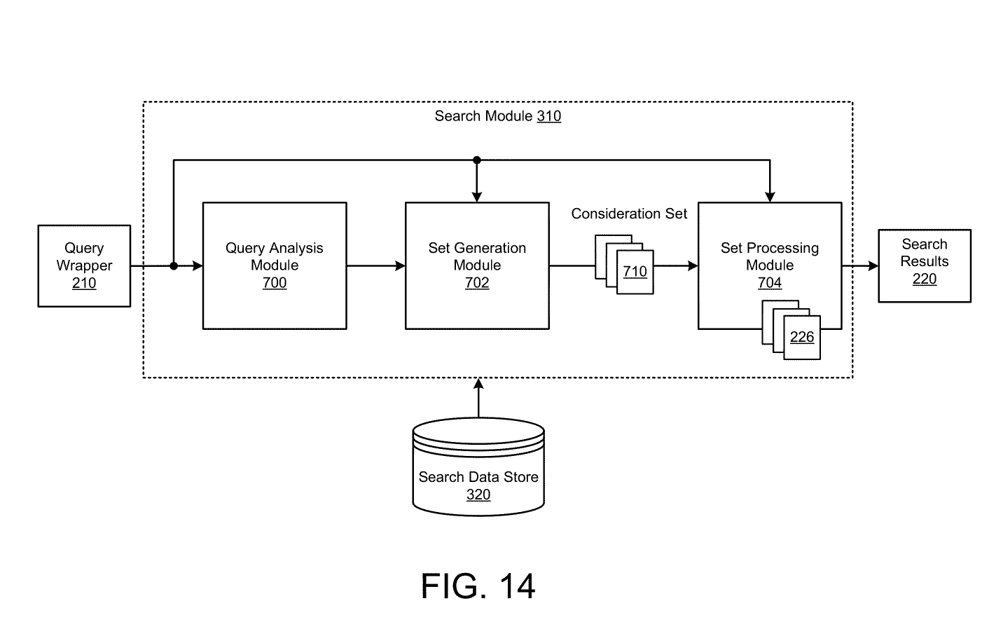

In some implementations, the search server generates individual state search results 220a and multi-state search results 220b based on a received query wrapper 210. In some implementations, the search data store 330 may store multi-state records 400 that include the data for generating multi-state results 220b. In these implementations, the search module 310 may identify multi-state records 400 using text- or keyword-based matching between terms of a search query 212 and terms included in the multi-state information 404. The search module 310 may assign result scores to the multi-state records 400 similarly to the manner in which application state records 340 are scored as described herein with respect to FIG. 14. In this way, the search system 300 may provide the multi-state records 220b corresponding to high-scoring multi-state records 400, thereby maximizing the likelihood that a user will find the corresponding multi-state result 220b to be relevant.

The search system 300 may generate multi-state records 400 using the record generation module 320. In some implementations, the multi-state records 400 may be generated manually by a system operator of the search system 300. In some implementations, a system operator may utilize the record generation module 320 to generate multi-state records 400 automatically based on user behavioral data and analytics. User behavioral data may be acquired from consenting user devices 200 and/or from the data sources 130 and may data indicate which states/applications users typically group together (e.g., states of applications that a user device 200 frequently launches sequentially or in parallel). For example, if the user behavioral data indicates that users 10 typically select one state of an application after another state of an application, the system operator and/or the record generation module 320 may generate a multi-state record 400 based on the application state records 340 of those two states. In a more specific example, users that make dinner reservations in one application may also navigate to the locations of the reservations using an application state of another application. In this example, the system operator and/or the record generation module 320 may generate a multi-state record 320 including references (e.g., access mechanisms 202, multi-state information 410, and multi-state link data 412) to a state of the dinner reservation application (e.g., the primary application state 270) and references to a state of the navigation application (e.g., a secondary application state 260). In some implementations, the system operator may generate a multi-state record based on a partnership between two application developers that wish to have their applications work together.

The user behavioral data may be collected and analyzed on a per-user basis so that the search system 300 can generate personalized multi-state results 220b. In other examples, the user behavioral data may be collected and analyzed on an aggregate basis (e.g., across a plurality of users). In these examples, the multi-state results 220b returned to an individual user 10 may not be personalized and instead reflect common trends across all users. In examples involving user behavioral data and analytics, the data may be collected only from consenting users and may be anonymized to protect the users' privacy.

In some implementations, the multi-state records 400 may be generated automatically by the record generation module 320 based on the user behavioral data and analytics. The record generation module 320 may operate automatically based on a scheme, guidelines, rules and/or templates defined by a system operator. In these examples, the record generation module 320 may analyze the user behavioral data to discover relationships between applications (e.g., which applications are launched in parallel by users and which applications are launched sequentially by users). The record generation module 320 may then generate multi-state records 400 based on the relationships it discovers and the application state records 340 of the corresponding application states. In some implementations, a system operator may manually identify certain trends or relationships and cause the record generation module 320 to generate multi-state records 220b matching to those trends or relationships. For example, a system operator may determine that navigation applications are frequently launched after a user has made a reservation in a reservation application. In this example, the system operator may instruct the record generation module 320 to generate multi-state records 400 for all reservation applications, whereby a state of a reservation application may be the primary state 260 and a state of a navigation application may be a corresponding secondary state 270. In another similar example, the system operator may instruct the record generation module 320 to generate multi-state records 400 that include primary application states 260 capable of performing the action “view movie review” and secondary states 270 capable of performing the action “buy movie tickets”. In yet another example, the system operator may cause the record generation module 320 to generate multi-state records 400 based on any partnerships between application developers known to the system operator. This disclosure contemplates the generation of multi-state records 400 via the use of automatic techniques, manual techniques, or any combination thereof.

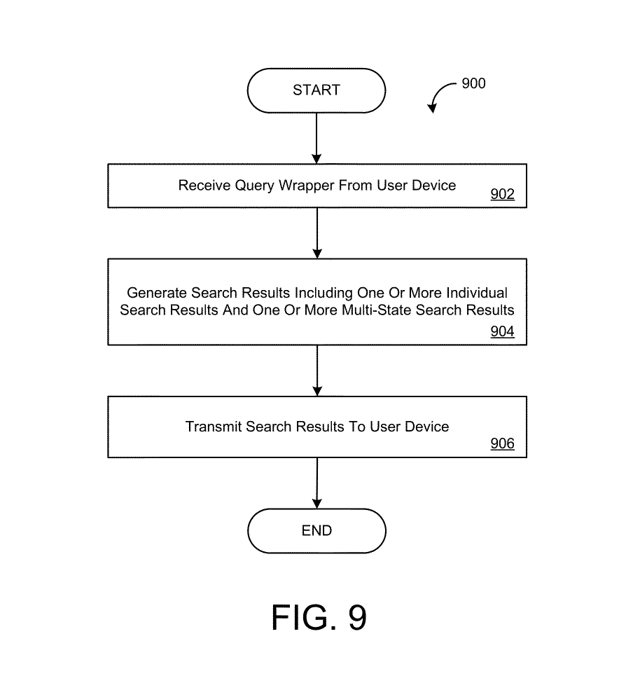

FIG. 9 shows an example method 900 for generating search results including multi-state search results 220b. At block 902, the search system 300 receives a query wrapper 210 from the user device 200. The query wrapper 210 may include a search query and a multi-state request 214 that indicates to the search system 300 that the user device 200 requests multi-state results 220b. The search system 300 may be configured to generate multi-state results 220b in response to receipt of the request for multi-state results 220b. Otherwise, in absence of the request for multi-state results 220b, the search system 300 may generate individual search results without multi-state search results 220b. At block 904, the search system 300 generates search results including individual search results and one or more multi-state search results 220b. The system can identify individual application state records 340 and multi-state records 400 in examples where multi-state records are included in the search system 300 (e.g., search data store). At block 906, the search system 300 transmits the search results including multi-state results 220b to the user device 200. In some implementations, the search system 300 may filter out links in multi-state search results 220b to applications that the user does not have installed. The search system 300 may determine whether a user device 200 has a particular application installed in a variety of different ways. In one example, the user may share with the search system 300 which applications are installed. In other examples, the user device 200 may insert a list of installed applications into the query wrapper that is transmitted to the search system 300.

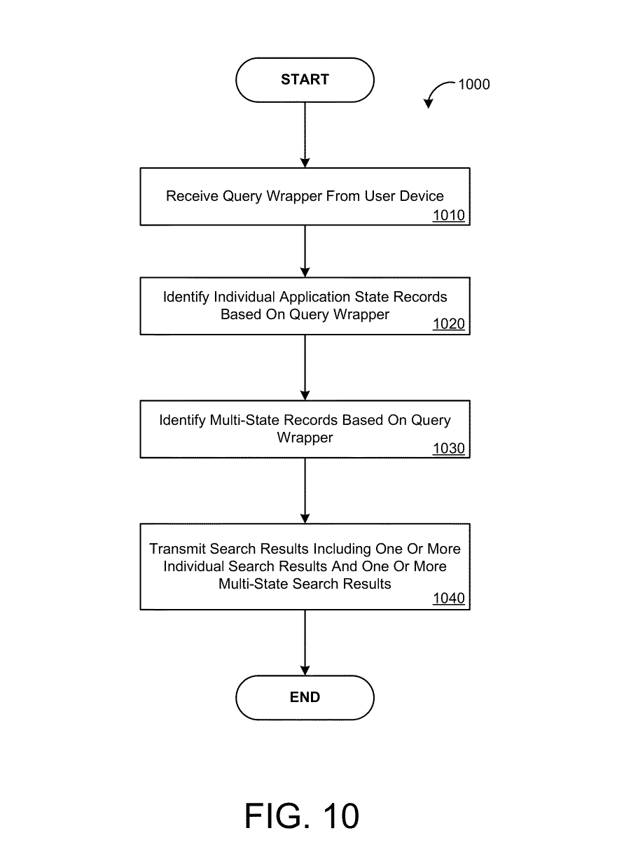

FIG. 10 illustrates example operations of a method 1000 for handling a multi-state request 214 at a search system 300. At block 1010, the search system 300 receives a query wrapper 210 from a user device 200. The query wrapper 210 may include a search query 212 and a multi-state request 214. At block 1020, the search system 300 identifies application state records corresponding to individual search results based on the search query 212 and any other information provided in the query wrapper 210. At block 1030, the search system 300 identifies multi-state records 400 based on the search query 212, the multi-state request 214, and any other information provided in the query wrapper 210. At block 1040, the search system 300 generates and transmits search results 220 including one or more individual results 220a and one or more multi-state results 220b to the requesting user device 200.

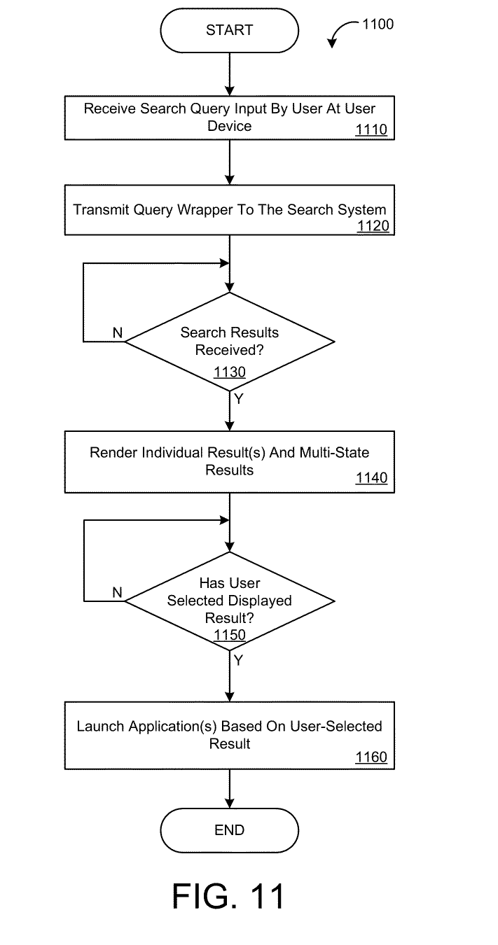

FIG. 11 illustrates example operations of a method 1100 for a user device 200 that receives multi-state results 220b in response to transmitting a query wrapper 210. At block 1110, the user device 200 receives a search query from a user. In some implementations, the search query may be entered into a text box appearing in a GUI of a search application 216. For example, a user may input a search query using the touch-display of the user device 200. In another example, a user may input a search query using a keyboard or other external device attached to the user device 200. In yet another example, a user may input a search query using voice-to-text recognition software, whereby a user may speak a search query aloud.

At block 1120, the user device 200 transmits a query wrapper 210 to a search system 300 including a search query 212 and a multi-state request 214. At block 1130, the user device 200 determines whether search results including individual results 220a and multi-state results 220b have been received. The example operations of the method 1100 proceed to block 1140 upon receipt of search results 220 from the search system 300. At block 1140, the user device 200 (via a multi-state module 217) renders and displays the individual results 220a and the multi-state results 220b as user-selectable links within a GUI (e.g., within an application state or in a launcher overlay). In some implementations, the search system 300 may not include any multi-state results 220b in the search results 220. In these examples, the user device 200 may only render and display individual results 220a.

At block 1150, the user device determines whether a user has selected a displayed search result 220. The example operations of the method 1100 proceed to block 1160 upon user selection of an individual result 220 or a multi-state result 220b. At block 1160, the user device 200 (e.g., via the multi-state module 217) launches the application state(s) associated with the selected result.

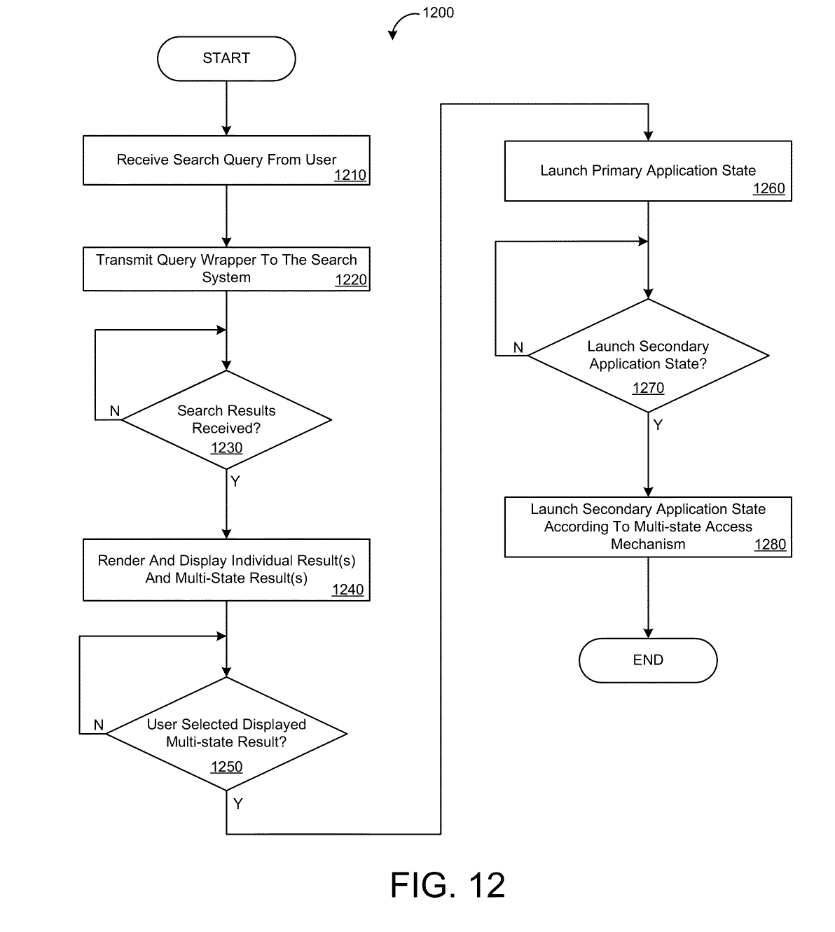

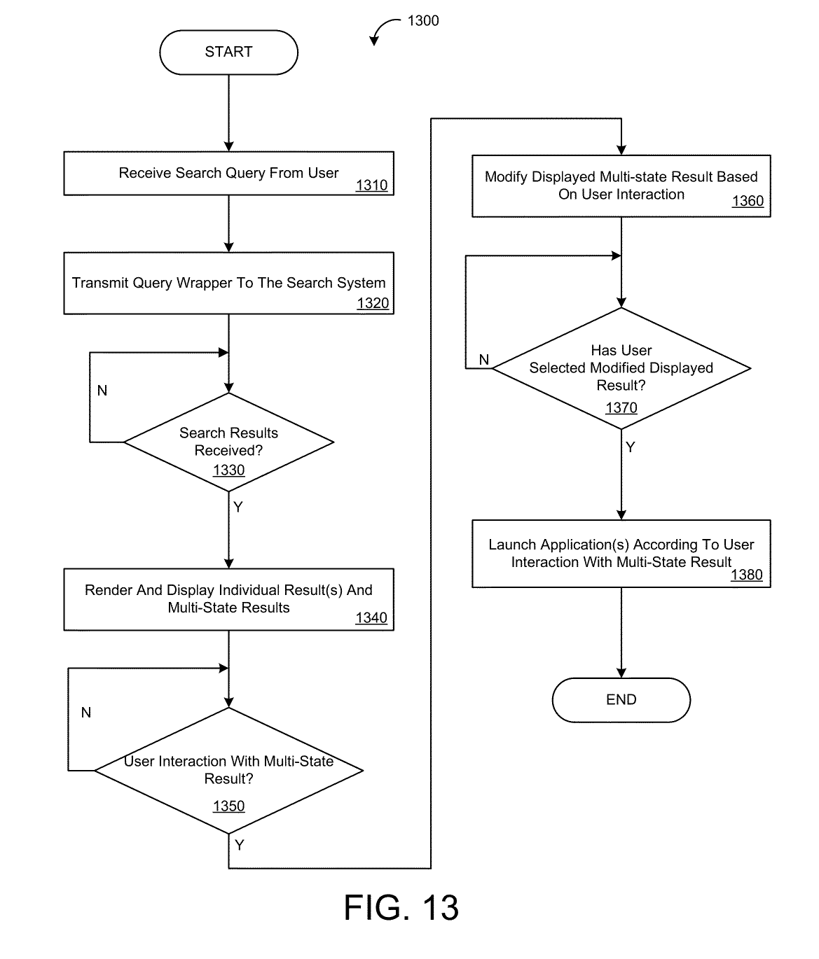

FIG. 12 illustrates example operations of a method 1200 for a user device 200 that receives multi-state results 220b. Specifically, the method describes sequential access of states included in a multi-state result 220b. At block 1210, the user device 200 receives a search query 212 input at the user device 200. For example, the search query 212 may be input as into a text box displayed on a GUI of the user device 200. A search query 212 may be input into the user device 200 in any reasonable manner. At block 1220, the user device 200 transmits a query wrapper 210 including the search query 212 and a multi-state request 214. The multi-state request 214 may be included in the query wrapper 210 by a multi-state module 217 executing on the user device 200 (e.g., as a part of a native application, an operating system, or as a separately executing launcher program).

At block 1230, the user device 200 determines whether it has received search results 220. The user device 200 proceeds to the operations of block 1240 upon receipt of the search results 220. At block 1240, the user device 200 renders and displays the individual results 220a and multi-state results 220b of the search results 220. At block 1250, the user device 200 determines whether the user has selected a displayed multi-state result 220b. The user device 200 proceeds to operations of block 1260 upon receipt of user selection (e.g., via a user click or touch) of a displayed multi-state result 220b. At block 1260, the user device 200 launches the primary application state 260 associated with the selected multi-state result 220b according to the multi-state access mechanisms 202 and the multi-state instructions 410 included in the multi-state result 220b.

At block 1270, the user device 200 determines whether to launch a secondary application state 270. It bears noting that in the case of parallel launched applications, the user device 200 (e.g., via the multi-state module 217) may launch every secondary state 270 in an analogous method instead of determining whether to launch a secondary state. Returning to block 1270, the user device 200 may determine whether to launch a secondary state 270 based on the multi-state instructions 410 (e.g., based on triggers indicated in the multi-state instructions). In one example, the multi-state instructions may indicate an amount of time to wait before launching a secondary state 270. In another example, the multi-state instructions 410 may indicate to render a link to a secondary state 270 within a current application state or in a launcher overlay. In this example, the user device 200 may launch a secondary state 270 upon user selection of the link. The user device 200 proceeds to the operations of block 1280 upon determining to launch a secondary application state. At block 1280, the user device launches a secondary application state 270 according to the multi-state instructions 410 and multi-state access mechanisms included in the selected multi-state result 220b.

FIG. 13 illustrates example operations of a method 1300 for a user device 200 that receives multi-state results 220b. Specifically, the method 1300 describes how a user may interact with a displayed multi-state result 220 (e.g., select secondary states 270). At block 1310, the user device 200 receives a search query 212 input at the user device 200. For example, the search query 212 may be input as into a text box displayed on a GUI of the user device 200. A search query 212 may be input into the user device 200 in any reasonable manner. At block 1320, the user device 200 transmits a query wrapper 210 including the search query 212 and a multi-state request 214. The multi-state request 214 may be included in the query wrapper 210 by a multi-state module 217 executing on the user device 200 (e.g., as a part of a native application, an operating system, or as a separately executing launcher program).

At block 1330, the user device 200 determines whether it has received search results 220. The user device 200 proceeds to the operations of block 1340 upon receipt of the search results 220. At block 1340, the user device 200 renders and displays the individual results 220a and multi-state results 220b of the search results 220. At block 1350, the user device 200 (e.g., via the multi-state module 217) determines whether a user has interacted with a displayed multi-state result 220b. For example, the user device 200 may determine whether a user device has selected or deselected an element of the GUI (e.g., a checkbox) corresponding to secondary states 270 related to the displayed multi-state result 220b. The user device 200 proceeds to the operation of block 1360 upon user interaction with the displayed multi-state result 220b. At block 1360, the user device 200 modifies the GUI displaying the multi-state result 220b according to user interaction (e.g., by placing a check in a checkbox). At block 1370, the user device 200 determines whether a user has selected the modified multi-state result 220b. The user device 200 proceeds to the operation of block 1380 upon user selection of the modified multi-state result 220b. At block 1380, the user device launches the primary application state 260. The user device 200 may additionally launch, either sequentially or in parallel, the secondary states 270 selected by the user at the previous blocks 1350, 1360.

FIG. 14 shows an example search module 310 that includes a query analysis module 700, a consideration set generation module 702 (hereinafter “set generation module 702”), and a consideration set processing module 704 (hereinafter “set processing module 704”). The query analysis module 700 receives the query wrapper 210 and analyzes the received search query 212. The query analysis module 700 may perform various analysis operations on the received search query 212, which may include, but are not limited to, tokenization of the search query 212, filtering of the search query 212, stemming, synonymization, and stop word removal. In some implementations, the query analysis module 700 detects a query-specified location included in the search query 212.

The set generation module 702 identifies a plurality of application state records 340 and multi-state records 400 based on the received search query 212. In some examples, the set generation module 702 identifies the application state records 340 and multi-state records 400 based on matches between terms of the search query 212 and terms in the application state records 340 and multi-state records 400. For example, the set generation module 702 may identify the application state records 340 based on matches between tokens generated by the query analysis module 700 and words included in the application state records 340, such as words included in the application state IDs 342 and/or the application state information 344. The set generation module 702 may identify the multi-state records 400 based on matches between tokens generated by the query analysis module 700 and words included in the multi-state records 400, such as words included in the multi-state IDs 402 and/or multi-state information 404.

The consideration set 710 of application state records 340 and multi-state records 400 may refer to the application state records 340 and multi-state records 400 that are to be scored by the set processing module 704. The set generation module 702 may determine the geo-location of the user device 200 based on data included in the query wrapper 210. In additional examples, if the query analysis module 700 detects a query-specified location, the set generation module 702 uses the query-specified location as the search location. In some examples, the set generation module 702 uses the geo-location of the user device 200 as the search location (e.g., to filter application state records 340 and multi-state records 400 based on location).

The set processing module 704 may score the application state records 340 and multi-state records 400 in the consideration set 710 in order to generate a set of search results 220. The scores 226 associated with the application state records 340 and multi-state records 400 may be referred to as “result scores.” The set processing module 704 may determine a result score 226 for each of the application state records 340 and multi-state records 400 in the consideration set 710. The result scores 226 associated with an application state record 340 or multi-state record 400 may indicate the relative rank of the application state record 340 or multi-state record 400 (e.g., by the access mechanisms 202) among other application state records 340 or multi-state records 400. For example, a larger result score 226 may indicate that an application state record 340 or multi-state record 400 is more relevant to the received search query 212.

The set processing module 704 selects application access mechanisms 202 from the selected application state records 340 and multi-state records 400 (e.g., the highest scoring records). The set processing module 704 transmits the selected application access mechanisms 202 to the user device 200 that generated the search query 212. The set processing module 704 may also transmit the result scores 226 associated with the selected application access mechanisms 202. For example, an application access mechanism 202 may be associated with the result score 226 of the application state record 340 or multi-state record 400 from which the application access mechanism 202 was selected.

The information conveyed by the search results 220 may depend on how the result scores 226 are calculated by the set processing module 704. For example, the result scores 226 may indicate the relevance of an application action or application state to the search query 212, the popularity of an application action or state, or other properties of the application action or state, depending on what parameters the set processing module 704 uses to score the application state records 340 and multi-state records 400.

The set processing module 704 may generate result scores 226 for application state records 340 and the multi-state records 400 in a variety of different ways. In some implementations, the set processing module 704 generates a result score 226 for an application state record 340 or multi-state record 400 based on one or more scoring features. The scoring features may be associated with an application state record 340 or a multi-state record 400, and/or the search query 212. A record scoring feature may be based on any data associated with an application state record 340 or multi-state record 400. For example, record scoring features may be based on any data included in the application state information 344 of the application state record 340 or the multi-state information 404 of the multi-state record 400. Example record scoring features may be based on metrics associated with a person, place, or thing described in the application state record 340 or multi-state record 400. Example metrics may include the popularity of a place described in the application state record 340 or multi-state record 400 and/or ratings (e.g., user ratings) of the place described in the application state record 340 or multi-state record 400. For example, if the application state record 340 or multi-state record 400 describes a song, a metric may be based on the popularity of the song described in the application state record 340 or multi-state record 400, and/or ratings (e.g., user ratings) of the song described in the application state record 340 or multi-state record 400. The record scoring features may also be based on measurements associated with the application state record 340 or multi-state record 400, such as how often the application state record 330 is retrieved during a search and how often access mechanisms 202 of the application state record 340 or multi-state record 400 are selected by a user 10. Record scoring features may also be based on whether the application state record 340 or multi-state record 400 includes an application access mechanism 202 that leads to a default state or a deeper native application state.

A query scoring feature may include any data associated with the search query 212. For example, query scoring features may include, but are not limited to, a number of words in the search query 212, the popularity of the search query 212, and the expected frequency of the words in the search query 212. A record-query scoring feature may include any data generated based on data associated with both the application state record 340 (or multi-state record 400) and the search query 212 that resulted in identification of the application state record 340 (or multi-state record 400) by the set generation module 702. For example, record-query scoring features may include, but are not limited to, parameters that indicate how well the terms of the search query 212 match the terms of the application state information 344 of the identified application state record 340 or to the terms of the multi-state information 404 of the identified multi-state record 400. The set processing module 704 may generate a result score 226 for an application state record 340 or multi-state record 400 based on at least one of the record scoring features, the query scoring features, and the record-query scoring features.

The set processing module 704 may determine a result score 226 for an application state record 340 or multi-state record 400 based on one or more of the scoring features listed herein and/or additional scoring features not explicitly listed. In some examples, the set processing module 704 may include one or more machine learned models (e.g., a supervised learning model) configured to receive one or more scoring features. The one or more machine learned models may generate result scores 226 based on at least one of the record scoring features, the query scoring features, and the record-query scoring features. For example, the set processing module 704 may pair the search query 212 with each application state record 340 (or multi-state record 400) and calculate a vector of features for each (query, record) pair. The vector of features may include one or more record scoring features, one or more query scoring features, and one or more record-query scoring features. The set processing module 704 may then input the vector of features into a machine-learned regression model to calculate a result score for the application state record 340 or multi-state record 400. In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

The result scores 226 associated with the application state records 340 and the multi-state records 400 (e.g., access mechanisms 202) may be used in a variety of different ways. The set processing module 704 and/or the user device 200 may rank the access mechanisms 202 based on the result scores 226 associated with the access mechanisms 202. In these examples, a larger result score may indicate that the access mechanism 202 (e.g., an action or application state) is more relevant to a user than an access mechanism 202 having a smaller result score. In examples where the user device 200 displays the search results 220 as a list, the user device 200 may display the links corresponding to access mechanisms 202 having larger result scores 226 nearer to the top of the results list (e.g., near to the top of the screen). In these examples, the user device 200 may display the links corresponding to access mechanisms 202 having lower result scores 226 farther down the list (e.g., off screen). In some examples the user device 200 groups together the links associated with the same native application 204a.

Modules and data stores included in the search system 300 represent features that may be included in the search system 300 of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

In some implementations, the search system 300 may be a system of one or more computing devices (e.g., a computer search system) that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the search system 300 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the search system 300 may be configured to communicate with the network 120. The one or more computing devices of the search system 300 may also be configured to communicate with one another (e.g., via a computer network). In some examples, the one or more computing devices of the search system 300 may include one or more server computing devices configured to communicate with user devices (e.g., receive query wrappers and transmit results), gather data from data sources 130, index data, store the data, and store other documents. The one or more computing devices may reside within a single machine at a single geographic location in some examples. In other examples, the one or more computing devices may reside within multiple machines at a single geographic location. In still other examples, the one or more computing devices of the search system 300 may be distributed across a number of geographic locations.

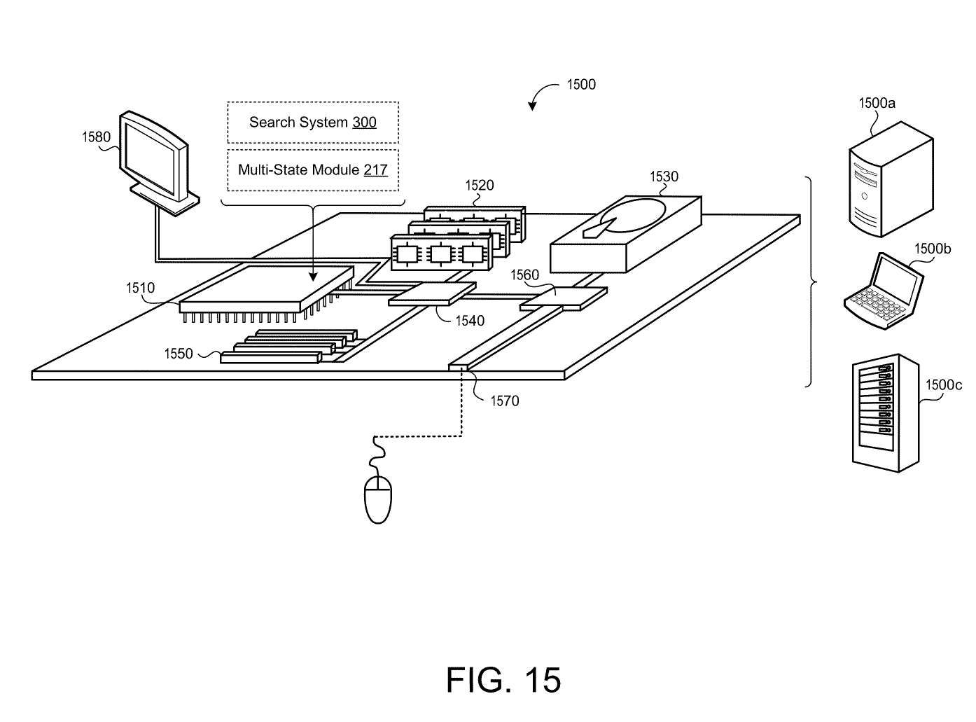

FIG. 15 is schematic view of an example computing device 1500 that may be used to implement the systems and methods described in this document. The computing device 1500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1500 includes a processor 1510, memory 1520, a storage device 1530, a high-speed interface/controller 1540 connecting to the memory 1520 and high-speed expansion ports 1550, and a low speed interface/controller 1560 connecting to low speed bus 1570 and storage device 1530. Each of the components 1510, 1520, 1530, 1540, 1550, and 1560, are interconnected using various busses, and may be mounted on a common motherboard or in other manners as appropriate. The processor 1510 can process instructions for execution within the computing device 1500, including instructions stored in the memory 1520 or on the storage device 1530 to display graphical information for a graphical user interface (GUI) on an external input/output device, such as display 1580 coupled to high speed interface 1540. In other implementations, multiple processors and/or multiple buses may be used, as appropriate, along with multiple memories and types of memory. Also, multiple computing devices 1500 may be connected, with each device providing portions of the necessary operations (e.g., as a server bank, a group of blade servers, or a multi-processor system).

The memory 1520 stores information non-transitorily within the computing device 1500. The memory 1520 may be a computer-readable medium, a volatile memory unit(s), or non-volatile memory unit(s). The non-transitory memory 1520 may be physical devices used to store programs (e.g., sequences of instructions) or data (e.g., program state information) on a temporary or permanent basis for use by the computing device 1500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1530 is capable of providing mass storage for the computing device 1500. In some implementations, the storage device 1530 is a computer-readable medium. In various different implementations, the storage device 1530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1520, the storage device 1530, or memory on processor 1510.

The high speed controller 1540 manages bandwidth-intensive operations for the computing device 1500, while the low speed controller 1560 manages lower bandwidth-intensive operations. Such allocation of duties is exemplary only. In some implementations, the high-speed controller 1540 is coupled to the memory 1520, the display 1580 (e.g., through a graphics processor or accelerator), and to the high-speed expansion ports 1550, which may accept various expansion cards (not shown). In some implementations, the low-speed controller 1560 is coupled to the storage device 1530 and low-speed expansion port 1570. The low-speed expansion port 1570, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 1500 may be implemented in a number of different forms, as shown in the figure. For example, it may be implemented as a standard server 1500a or multiple times in a group of such servers 1500a, as a laptop computer 1500b, or as part of a rack server system 1500c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
transmitting, by a processing system included in a user device, a query wrapper including a search query and a multi-state request to a remote device;
receiving, by the processing system, search results from the remote device, the search results including a multi-state result, the multi-state result including multi-state instructions and access mechanisms configured to launch a primary application state and one or more secondary application states;
displaying, by the processing system, the multi-state result as a primary user-selectable link in a search engine results page, the primary user-selectable link indicating the primary application state; and
in response to receiving a user selection of the primary user-selectable link, launching, by the processing system, the primary application state indicated by the multi-state result according to the multi-state instructions and the access mechanisms.

2. The method of claim 1, further comprising in response to receiving the user selection of the primary user-selectable link, launching, by the processing system, the one or more secondary application states indicated by the multi-state result according to the multi-state instructions and the access mechanisms.

3. The method of claim 2, wherein the one or more secondary application states are launched in parallel or sequentially.

4. The method of claim 1, further comprising:
displaying, by the processing system, the launched primary application state;
displaying, by the processing system, one or more secondary user-selectable links associated with the one or more secondary application states within the launched primary application state;
receiving, by the processing system, a user selection of one of the one or more secondary user-selectable links; and
launching, by the processing system, the secondary application state associated with the selected secondary user-selectable link.

5. The method of claim 4, wherein displaying the one or more secondary user-selectable links comprises generating a graphical overlay in a graphical user interface displaying the launched primary state.

6. The method of claim 4, further comprising:
displaying, by the processing system, the launched secondary application state; and
displaying, by the processing system, the primary user-selectable link to the primary application state within the displayed launched secondary application state.

7. The method of claim 4, further comprising:
displaying, by the processing system, the launched secondary application state; and
displaying, by the processing system, the one or more secondary user-selectable links to the one or more secondary application states within the displayed launched secondary application state.

8. The method of claim 1, wherein displaying the multi-state result includes displaying one or more secondary user-selectable links indicating the one or more secondary application states.

9. The method of claim 1, wherein the multi-state result includes an interactive graphical user interface element allowing selection or de-selection of the one or more secondary user-selectable links.

10. The method of claim 9, further comprising:
receiving one or more selections or de-selections of the one or more secondary user-selectable links; and
launching the secondary application state corresponding to any selected secondary user-selectable link.

11. A system comprising:
a user device including a processing system, the processing system including one or more processors that execute computer-readable instructions, the computer readable instructions, when executed by the processing system, causing the processing system to perform operations comprising:
transmitting a query wrapper including a search query and a multi-state request to a remote device;
receiving search results from the remote device, the search results including a multi-state result, the multi-state result including multi-state instructions and access mechanisms configured to launch a primary application state and one or more secondary application states;
displaying the multi-state result as a primary user-selectable link in a search engine results page, the primary user-selectable link indicating the primary application state; and
in response to receiving a user selection of the primary user-selectable link, launching the primary application state indicated by the multi-state result according to the multi-state instructions and the access mechanisms.

12. The system of claim 11, wherein the operations further comprise, in response to receiving the user selection of the primary user-selectable link, launching, by the processing system, the one or more secondary application states indicated by the multi-state result according to the multi-state instructions and the access mechanisms.

13. The system of claim 12, wherein the one or more secondary application states are launched parallel or sequentially.

14. The system of claim 11, wherein the operations further comprise:
displaying the launched primary application state;
displaying one or more secondary user-selectable links associated with the one or more secondary application states within the launched primary application state;
receiving a user selection of one of the one or more secondary user-selectable links; and
launching the secondary application state associated with the selected secondary user-selectable link.

15. The system of claim 14, wherein displaying the one or more secondary user-selectable links comprises generating a graphical overlay in a graphical user interface displaying the launched primary state.

16. The system of claim 14, wherein the operations further comprise:
displaying the launched secondary application state; and
displaying the primary user-selectable link to the primary application state within the displayed launched secondary application state.

17. The system of claim 14, wherein the operations further comprise:
displaying the launched secondary application state; and
displaying the one or more secondary user-selectable links to the one or more secondary application states within the displayed launched secondary application state.

18. The system of claim 11, wherein displaying the multi-state result includes displaying one or more secondary user-selectable links indicating the one or more secondary application states.

19. The system of claim 11, wherein the multi-state result includes an interactive graphical user interface element allowing selection or de-selection of the one or more secondary user-selectable links.

20. The system of claim 19, wherein the operations further comprise:
receiving one or more selections or de-selections of the one or more secondary user-selectable links; and
launching the secondary application state corresponding to any selected secondary user-selectable link.
